(19) United States
(12) Patent Application Publication
(10) Pub. No.: US 2025/0034048 A1
(43) Pub. Date: Jan. 30, 2025

(54) RESIN FORMULATIONS AND RELATED ARTICLES AND METHODS

(71) Applicant: Northrop Grumman Systems Corporation, Falls Church, VA (US)

(72) Inventors: Benjamin W. C. Garcia, Tremonton, UT (US); Maziar A. Behtash, Phoenix, AZ (US)

(21) Appl. No.: 18/360,591

(22) Filed: Jul. 27, 2023

(51) Int. Cl. C04B 35/571; B28B 1/42; C04B 35/626; C04B 35/628; C04B 35/80; F01D 25/00; F02K 9/97

(52) U.S. Cl. CPC C04B 35/571; B28B 1/42; C04B 35/6269; C04B 35/62876; C04B 35/80; F01D 25/005; F02K 9/974; C04B 2235/483; C04B 2235/5248; C04B 2235/5427; C04B 2235/6028; C04B 2235/606; C04B 2235/96; F05D 2300/6033

(57) ABSTRACT

A resin formulation is disclosed. The resin formulation includes, before cure, at least one polymer derived ceramic (PDC) resin, and carbon fibers. The carbon fibers may include one or more metals. The resin formulation may be at least substantially free of a solvent. Related articles and methods are also disclosed.

### TECHNICAL FIELD

Embodiments of the disclosure relate generally to resin formulations that are electrically conductive and resistant to one or more of heat, moisture, and oxidation when cured and/or ceramified. More particularly, embodiments of the disclosure relate to resin formulations that include a polycarbosilane preceramic polymer, an organically modified silicon dioxide preceramic polymer, and carbon fibers, articles formed from the resin formulations, and related methods of forming the resin formulations and articles.

### BACKGROUND

Electromagnetic interference (EMI), such as laser energy, microwave energy, and electromagnetic pulse energy, can have detrimental effects on electronic devices, equipment, and systems. EMI shielding capable of absorbing, reflecting, and/or redirecting the EMI energy is desirable in aerospace and other industries to protect electronic devices and equipment from the effects of EMI. Effective EMI shielding materials are electrically conductive, where a level of shielding is proportional to the conductivity of the material. Coatings of metals, conductive polymers, and carbon black particles are used in EMI shielding. However, metals used for EMI shielding are often heavy and subject to corrosion (e.g., oxidation). While conductive polymers and carbon black particles are lightweight, they exhibit a lower conductivity than that of metal, resulting in less effective EMI shielding.

Silicon carbide (SiC) and other ceramic materials are used to produce ceramic matrix composites (CMCs) having high structural and mechanical strength at a temperature above about 1,200° C. (above about 2,200° F.), which are commonly used in aerospace and other industries where resistance to heat (e.g., high temperatures) is desired. However, conventional CMCs are expensive and time intensive to produce by conventional precursor impregnation and pyrolysis, slurry infiltration, reactive melt infiltration, or chemical vapor infiltration techniques. Processing of the CMCs requires multiple heat treatments and processing acts to densify the materials and provide the desired strength. Producing CMCs requires several infiltration cycles, which increases the overall cost and amount of time to fabricate the CMCs. Additionally, conventional furnaces used to produce the articles are not sufficiently large to accommodate large articles, such as those needed for large rocket motors.

One method of forming SiC and other ceramic materials is from preceramic polymers. However, conventional preceramic polymers, such as polycarbosilanes, have a low viscosity (less than about 200 cP), which limits their practical use in the preparation of CMCs where the preceramic polymer provides the matrix of the CMC. One commonly-used preceramic polymer is polycarbosilane. However, the polycarbosilane has limited use due to its low viscosity and extensive cracking after curing at, for example, about 121° C. (about 250° F.). Additionally, the ceramic materials formed from conventional preceramic polymers exhibit high mass loss, extensive cracking at low temperature (less than about 121° C.), high porosity, and high shrinkage. Porosity of the ceramic materials is increased with the addition of solvents and volatiles to the preceramic polymers. Cracking of the ceramic material is worsened as high loading of fillers is needed, rendering the ceramic material formed from the conventional preceramic polymers ineffective. Viscosity modifiers or cracking mitigation additives have been used with conventional preceramic polymers. However, with the modifiers or additives, a low ceramic yield is observed at a temperature greater than about 816° C. (greater than about 1,500° F.). Polycarbosilane has also been combined with a polysiloxane, such as polydimethylsiloxane, to improve its viscosity.

### BRIEF SUMMARY

In accordance with some embodiments described herein, a resin formulation is disclosed. The resin formulation comprises, before cure, at least one polymer derived ceramic (PDC) resin, and carbon fibers comprising one or more metals. The resin formulation is at least substantially free of a solvent.

In accordance with other embodiments, an article is disclosed and comprises a fibrous reinforcement material, a reaction product of at least one PDC resin, and carbon fibers. At least one of the fibrous reinforcement material and the carbon fibers comprises one or more metals.

In additional embodiments, a method of forming an article is disclosed. The method comprises impregnating a fibrous reinforcement material with a resin formulation, forming the impregnated fibrous reinforcement material into a desired shape, and curing the impregnated fibrous reinforcement material to form the article. The resin formulation comprises, before cure, at least one PDC resin, and fibers including carbon and at least one metal, and is substantially free of a solvent.

### BRIEF DESCRIPTION OF THE DRAWINGS

FIG. 1 is a simplified flow diagram depicting a method of forming a fiber reinforced article in accordance with embodiments of the disclosure;

FIG. 2 is a simplified cross-sectional view of a rocket motor including one or more components formed from a resin formulation in accordance with embodiments of the disclosure; and

FIG. 3 is a simplified block diagram depicting a fiber reinforced article in accordance with embodiments of the disclosure.

### DETAILED DESCRIPTION

Resin formulations, articles formed from reaction products of resin formulations, and methods of forming articles are disclosed.

The resin formulations include at least one polymer derived ceramic (PDC) resin and fibers. The fibers may be carbon fibers. The carbon fibers may include one or more metals. The resin formulations may be at least substantially free of a solvent. The PDC resin may include at least one polycarbosilane preceramic polymer, at least one organically modified silicon dioxide preceramic polymer, or combinations thereof. By appropriately selecting viscosities of the at least one polycarbosilane preceramic polymer and the at least one organically modified silicon dioxide preceramic polymer and the length of the carbon fibers, the viscosity of the resin formulation is tailorable. For example, the viscosity of the resin formulation may be tailored to enable forming an article via a wet filament winding process. The resin formulation may be formulated to be electrically conductive at a temperatures as high as about 3000° F. (about 1649° C.). The article may be used as shielding from electromagnetic energy at a high temperature, such as shielding from laser energy, microwave energy, or electromagnetic pulse energy at a temperature up about 3000° F. (about 1649° C.).

The resin formulations may be cured (e.g., crosslinked) to form a composite material. The composite material may, optionally, be ceramified (e.g., pyrolyzed) to form a ceramic material (e.g., CMC). After curing, the resin formulation functions as a matrix of the composite material, with the carbon fibers in the matrix. The composite material and the ceramic material may be formulated to exhibit desired material properties (e.g., rheological properties, mechanical properties, physical properties, chemical properties, thermal properties), such as electrical conductivity and resistance to one or more of heat, moisture, and oxidation at temperatures between about 2,000° F. (about 1,093° C.) and about 5,000° F. (about 2,760° C.).

The composite material may be formed by the wet filament winding process, allowing the composite material and/or the ceramic material to be formed at a significantly lower cost compared to conventional CMCs. A fibrous reinforcement material used in the wet filament winding process may include one or more metals. The wet filament winding process also enables the composite material and/or the ceramic material to be produced by a semi-automated process or an automated process. The composite material and the ceramic material may be used in a wide variety of applications, such as in high temperature, shielding applications.

As used herein, the singular forms following “a,” “an,” and “the” are intended to include the plural forms as well, unless the context clearly indicates otherwise.

As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be excluded.

As used herein, the term “and/or” includes any and all combinations of one or more of the associated listed items.

As used herein, the term “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, spatially relative terms, such as “beneath,” “below,” “lower,” “bottom,” “above,” “over,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped, etc.) and the spatially relative descriptors used herein interpreted accordingly.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “configured” refers to a size, shape, material composition, and arrangement of one or more of at least one structure and at least one apparatus facilitating operation of one or more of the structure and the apparatus in a pre-determined way.

As used herein, the term “preceramic” means and includes a polymer material that is converted to a ceramic material when heated to a temperature of greater than about 649° C. (greater than about 1,200° F.).

As used herein, the term “composite material” means and includes a reaction product of the polycarbosilane preceramic polymer and the organically modified silicon dioxide preceramic polymer following cure of the resin formulation and before ceramification.

As used herein, the term “cured resin formulation” means and includes the resin formulation after curing and before ceramification.

As used herein, the term “ceramic material” means and includes a reaction product of the polycarbosilane preceramic polymer and the organically modified silicon dioxide preceramic polymer following cure and ceramification of the resin formulation.

As used herein, the term “ceramified resin formulation” means and includes the resin formulation after curing and ceramification.

As used herein, the term “ceramic yield” means and includes a residual mass of the composite material remaining after cure at from about 0° C. (about 32° F.) to about 400° C. (about 752° F.) and/or ceramification of the resin formulation at a temperature of about 1,200° C. (about 2,192° F.) or greater.

A resin formulation (e.g., preceramic resin formulation), according to embodiments of this disclosure, includes, before cure, at least one polymer derived ceramic (PDC) resin and carbon fibers. In some embodiments, the polymer derived ceramic resin includes a polycarbosilane preceramic resin and/or at least one organically modified silicon dioxide preceramic polymer. In some embodiments, the carbon fibers include one or more metals. In some embodiments, the resin formulation is at least substantially free of a solvent. The resin formulation may be formulated to exhibit a viscosity at room temperature that is suitable (e.g., formulated) for impregnating a filament or a fibrous material and subsequent filament winding. The resin formulation may be cured to form articles that exhibit desired material properties (e.g., rheological properties, mechanical properties, physical properties, chemical properties, thermal properties), such as electrical conductivity and resistance to one or more of heat, moisture, and oxidation at temperatures between about 2,000° F. (about 1,093° C.) and about 5,000° F. (about 2,760° C.).

The polycarbosilane preceramic polymer may have a viscosity of less than or equal to about 250 cP at a temperature of about 25° C. The polycarbosilane preceramic polymer may be formed of monomers having the following chemical structure:

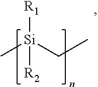

where R₁ and R₂ of each monomer is independently a hydrogen (H) group, a methyl (CH₃) group, or a vinyl group (CH₂═CH) and n is an integer from 2 to 10,000 (e.g., from 100 to 5,000). When vinyl groups are present, the vinyl group may be directly bonded to the silicon atom or may be bonded to the silicon atom by an alkyl group or other linker. By way of example only, the alkyl group may include from one carbon atom to six carbon atoms. At least a portion of the monomers in the polycarbosilane preceramic polymer include the vinyl group as R₁ or R₂ to enable crosslinking with the organically modified silicon dioxide preceramic polymer during cure of the resin formulation. The amount of vinyl groups in the polycarbosilane preceramic polymer may be sufficient to crosslink the resin formulation. The polycarbosilane preceramic polymer may include at least about 0.01 vinyl eq/kg, such as from about 0.2 vinyl eq/kg to about 5.0 vinyl eq/kg. The polycarbosilane preceramic polymer may also include at least about 0.01 hydride eq/kg, such as from about 0.2 hydride eq/kg to about 10 hydride eq/kg. The polycarbosilane preceramic polymer may be photocurable, chemically curable, or thermally curable.

By selecting the R₁ and R₂ groups of each monomer and the degree of polymerization (i.e., the number of monomer repeat units), a desired viscosity of the polycarbosilane preceramic polymer may be achieved. The polycarbosilane preceramic polymer may be formulated to exhibit a viscosity of less than or equal to about 250 cP at a temperature of about 25° C., such as from about 1 cP to about 250 cP at about 25° C., from about 1 cP to about 200 cP at about 25° C., from about 1 cP to about 100 cP at about 25° C., from about 10 cP to about 250 cP at about 25° C., from about 10 cP to about 200 cP at about 25° C., from about 40 cP to about 250 cP at about 25° C., from about 40 cP to about 200 cP at about 25° C., from about 40 cP to about 120 cP at about 25° C., from about 40 cP to about 100 cP at about 25° C., from about 5 cP to 8 cP at about 25° C., from about 4 cP to about 7 cP at about 25° C., from about 8 cP to about 12 cP at about 25° C., from about 8 cP to about 15 cP at about 25° C., or from about 200 cP to about 250 cP at about 25° C. In some embodiments, the polycarbosilane preceramic polymer has a viscosity of from about 40 cP to about 120 cP at about 25° C.

Such polycarbosilane preceramic polymers are commercially available from numerous sources including, but not limited to, EEMS, LLC (Saratoga Springs, NY), Starfire Systems, Inc. (Schenectady, NY), or Matech (Westlake Village, CA). The polycarbosilane preceramic polymer may include, but is not limited to, SMP-10, STARPCS® SMP-500, or STARPCS® SMP-877 silicon carbide precursor resin from Starfire Systems, Inc. (Malta, NY). Additional polycarbosilane preceramic polymers are commercially available from EEMS, LLC as MS 208, MS 272, MS 250, MS 440, CSO 110, or CSO 116. The polycarbosilane preceramic polymer may also include a combination of polycarbosilane preceramic polymers or a combination of the polycarbosilane preceramic polymer with at least one other polymer, such as a polysiloxane or other compatible polymer. The polycarbosilane preceramic polymer may be available at a relatively low cost, such as less than about $100/pound.

The organically modified silicon dioxide precursor resin may have a viscosity of greater than or equal to about 2,500 cP at a temperature of about 25° C. The organically modified silicon dioxide precursor resin may be an organically modified silicon dioxide preceramic polymer formed of monomers having the following chemical structure:

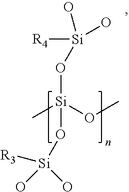

where each of R₃ and R₄ is independently a methyl (CH₃) group or a vinyl group (CH₂═CH) and n is an integer from 2 to 10,000 (e.g., from 100 to 5,000). When vinyl groups are present, the vinyl group may be directly bonded to the silicon atom or may be bonded to the silicon atom by an alkyl group or other linker. By way of example only, the alkyl group may include from one carbon atom to six carbon atoms. The organically modified silicon dioxide preceramic polymer includes a quaternary coordinated (QC) oxygen to silicon atom and may also be referred to as a QC silicon dioxide preceramic polymer. At least a portion of the monomers in the organically modified silicon dioxide preceramic polymer may, optionally, include the vinyl group as R₃ or R₄ to enable crosslinking with the polycarbosilane preceramic polymer during cure of the resin formulation. The organically modified silicon dioxide preceramic polymer may include from about 0 vinyl eq/kg to about 5.0 vinyl eq/kg, such as from about 0.18 vinyl eq/kg to about 0.3vinyl eq/kg. The organically modified silicon dioxide preceramic polymer may be photocurable, chemically curable, or thermally curable.

R₃ and R₄ of each monomer of the organically modified silicon dioxide preceramic polymer and the degree of polymerization are selected to provide the desired viscosity to the organically modified silicon dioxide preceramic polymer. The organically modified silicon dioxide preceramic polymer also has a low carbon content and a high degree of quaternary coordinated oxygen to the silicon atoms in the polymer chain. The organically modified silicon dioxide preceramic polymer is formulated to exhibit a viscosity greater than about 200 cP at a temperature of about 25° C., such as greater than about 2,500 cP at a temperature of about 25° C., from about 3,000 cP to about 100,000 cP at about 25° C., from about 4,000 cP to about 100,000 cP at about 25° C., from about 5,000 cP to about 100,000 cP at about 25° C., from about 6,000 cP to about 100,000 cP at about 25° C., from about 4,500 cP to about 7,000 cP at about 25° C., from about 40,000 cP to about 80,000 cP at about 25° C., from about 45,000 cP to about 75,000 cP at about 25° C., from about 50,000 cP to about 70,000 cP at about 25° C., or from about 50,000 cP to about 60,000 cP at about 25° C. In some embodiments, the organically modified silicon dioxide preceramic polymer has a viscosity of from about 50,000 cP to about 60,000 cP at a temperature of about 25° C. In other embodiments, the organically modified silicon dioxide preceramic polymer has a viscosity of from about 4,500 cP to about 7,000 cP at about 25° C.

Such organically modified silicon dioxide preceramic polymers are commercially available from numerous sources including, but not limited to, Gelest, Inc. (Morrisville, PA). The organically modified silicon dioxide preceramic polymer may include, but is not limited to, VQM 135, VQM 135R, VQM 146, HQM 105, HQM 107, or combinations thereof.

Relative amounts of the polycarbosilane preceramic polymer and the organically modified silicon dioxide preceramic polymer may be adjusted to tailor the mechanical properties and performance properties of the resin formulation after cure. The resin formulation may include from about 8.5% by weight (wt %) to about 90 wt % of the polycarbosilane preceramic polymer, such as from about 8.5 wt % to about 50 wt %, from about 20 wt % to about 80 wt %, from about 50 wt % to about 80 wt %, or from about 48.5 wt % to about 90 wt %. The resin formulation may include from about 8.5 wt % to about 90 wt % of the organically modified silicon dioxide preceramic polymer, such as from about 8.5 wt % to about 50 wt %, from about 20 wt % to about 80 wt %, from about 50 wt % to about 80 wt %, or from about 48.5 wt % to about 90 wt % of the organically modified silicon dioxide preceramic polymer. In some embodiments, the resin formulation includes from about 48.5 wt % to about 90 wt % of the polycarbosilane preceramic polymer and from about 8.5 wt % to about 50 wt % of the organically modified silicon dioxide preceramic polymer. In some embodiments, the resin formulation includes about 78 wt % of the polycarbosilane preceramic polymer and about 19.5 wt % of the organically modified silicon dioxide preceramic polymer.

While embodiments described herein refer to preceramic precursors of silicon carbide and silicon dioxide, the organically modified silicon dioxide preceramic polymer may also be used with preceramic precursors of other ceramics, such as preceramic precursors of silicon carbide, preceramic precursors of silicon nitride, preceramic precursors of silicon hexaboride, preceramic precursors of aluminum nitride, preceramic precursors of boron nitride, preceramic precursors of boron carbide, preceramic precursors of titanium boride, preceramic precursors of titanium carbide, and preceramic precursors of hafnium carbide.

The carbon fibers may be resistant to temperatures to which the cured resin formulation is exposed during use and operation of an article including the cured resin formulation. The carbon fibers may include, but are not limited to, polyacrylonitrile (PAN)-based carbon fibers, pitch-based carbon fibers, rayon-based carbon fibers, graphite fibers, or any other suitable carbon fibers. The carbon fibers may be thermally stable at temperatures greater than about 2,000° F. (about 1,093° C.), such as greater than about 2,500° F. (about 1,371° C.), or greater than about 3,000° F. (about 1,649° C.). In some embodiments, the carbon fibers include one or more metals. The carbon fibers may be electrically conductive at temperatures greater than about 2,000° F. (about 1,093° C.), such as greater than about 2,500° F. (about 1,371° C.), greater than about 3,000° F. (about 1,649° C.), or greater than about 5,000° F. (about 2,760° C.). The carbon fibers may not degrade at processing temperatures, including temperatures to which the resin formulation is exposed during cure and formation of an article including the cured resin formulation. While carbon fibers are described in detail herein, the fibers may be formed of and include a different material as an alternative to or in addition to the carbon fibers. For example, the fibers may include one or more of polymer fibers and ceramic fibers. The polymer fibers may include, but are not limited to, nylon fibers, polyester fibers, cellulose fibers, or any suitable polymer fibers. The ceramic fibers may include, but are not limited to, silica fibers, alumina fibers, borosilicate fibers, mullite fibers, silicon carbide fibers, or combinations thereof.

In some embodiments, the carbon fibers are chopped carbon fibers. In other words, in some embodiments, the carbon fibers have a definite length. The carbon fibers may have a length of from about 100 microns (μm) to about 3,000 μm, such as, for example, from about 100 μm to about 2,500 μm, from about 200 μm to about 1,500 μm, from about 500 μm to about 1,500 μm, or from about 800 μm to about 1,200 μm. In some embodiments, the carbon fibers may have a length of about 1,000 μm. In some embodiments, lengths of the carbon fibers may include two or more monomodal length distributions. The carbon fibers may be at least substantially homogeneous, wherein each of the carbon fibers exhibit at least substantially the same material composition, length, and size, or may be heterogeneous, wherein at least one of the carbon fibers exhibits one or more of a different material composition, a different length, or a different size than at least one of the other carbon fibers. The length of the carbon fibers may affect the viscosity of the resin formulation. In some embodiments, a length of the carbon fibers is selected such that the resin formulation exhibits a desired viscosity of from about 200 cP to about 15,000 cP at about 25° C. The length of the carbon fibers may be determined by forming the lowest viscosity resin formulation at the lowest concentration of carbon fibers. In some embodiments, the length of the carbon fibers is about 1,000 μm and a viscosity of the resin formulation is about 1,000 cP at about 25° C.

The one or more metals may be incorporated into the carbon fibers. The one or more metals may be homogeneously distributed or heterogeneously distributed in the carbon fibers. In some embodiments, the carbon fibers are coated (e.g., metallized) with the one or more metals. The one or more metals may exhibit a melting temperature greater than about 900° F. (greater than about 482° C.), such as, for example, greater than about 1,000° F. (greater than about 538° C.), greater than about 1,500° F. (greater than about 816° C.), greater than about 1,900° F. (greater than about 1,038° C.), greater than about 2,000° F. (greater than about 1,093° C.), or greater than about 3,000° F. (greater than about 1,649° C.). The metal may include one or more of copper, nickel, gold, silver, palladium, platinum, molybdenum, rhenium, and niobium or an alloy of the metals. The carbon fibers may be coated with one coating or multiple coatings of one or more combinations (e.g., alloys) of the one or more metals, one coating or multiple coatings of a single metal material, or a combination thereof. The carbon fibers may be coated with a concentration graded coating of the one or more metals.

The carbon fibers may be coated with a bilayer coating including two metals. In some embodiments, the carbon fibers are coated with a copper/nickel bilayer. A copper coating may be formed over (e.g., directly adjacent to) the carbon fiber and a nickel coating may be formed over (e.g., directly adjacent to) the copper coating. In some embodiments, the copper/nickel bilayer includes a concentration gradient of copper and nickel. As a non-limiting example, a concentration of copper may be highest adjacent to the carbon fibers and lowest adjacent an exterior surface of the bilayer coating and a concentration of nickel may be highest adjacent an exterior surface of the bilayer coating and lowest adjacent to the carbon fibers. In other embodiments, the copper/nickel bilayer includes a homogeneous copper coating over the carbon fiber and a homogeneous nickel coating over the homogeneous copper coating.

The metal may be present in the carbon fibers at an amount within a range of from about 10 wt % to about 60 wt %, such as, for example, from about 10 wt % to about 50 wt %, from about 15 wt % to about 55 wt %, from about 20 wt % to about 50 wt %, from about 20 wt % to about 45 wt %, from about 20 wt % to about 35 wt %, from about 25 wt % to about 40 wt %, from about 30 wt % to about 50 wt %, from about 30 wt % to about 60 wt %, or from about 40 wt % to about 60 wt %. The carbon fibers including the one or more metals may exhibit an electric conductivity within a range of from about 1×10⁴ S/m to about 1×10⁷ S/m.

Such carbon fibers including one or more metals are commercially available from numerous sources including, but not limited to, Grafil, Inc. (Sacramento, CA), Toho Tenax Co., Ltd. (Chiyoda, JP), Toray Industries, Inc. (Tokyo, JP), SGL Carbon SE (Wiesbaden, DE), and Hexcel Co. (Salt Lake City, UT).

The resin formulation may be formulated to include an amount of carbon fiber suitable to tailor the viscosity of the resin formulation for a subsequent article manufacturing process and/or to enable electrical conductivity of the resin formulation after cure and of an article including the cured resin formulation. The resin formulation may include the carbon fiber at from about 0.2% by volume (vol %) to about 1.5 vol %, such as from about 0.2 vol % to about 0.5 vol %, from about 0.2 vol % to about 0.8 vol %, from about 0.5 vol % to about 1.0 vol %, from about 0.5 vol % to about 1.5 vol %, from about 0.7 vol % to about 1.0 vol %, from about 0.8 vol % to about 1.2 vol %, or from 1.0 vol % to about 1.5 vol %. In some embodiments, the resin formulation includes the carbon fibers at an amount of at least about 0.5 vol %. The resin formulation may include the carbon fibers at from about 0.6 wt % to about 10.0 wt %, such as from about 0.6 wt % to about 9.0 wt %, from about 1.0 wt % to about 10.0 wt %, from about 1.0 wt % to about 5.0 wt %, from about 1.5 wt % to about 3.0 wt %, from about 3.0 wt % to about 10.0 wt %, from about 3.0 wt % to about 6.0 wt %, from about 5.0 wt % to about 8.0 wt %, from about 5.0 wt % to about 10.0 wt %, or from about 8.0 wt % to about 10.0 wt %.

In some embodiments, the resin formulation is at least substantially free of solvents and volatile compounds. In some embodiments, the resin formulation includes at least substantially all solids. The resin formulation may be formulated to exhibit a viscosity within a range of from about 200 cP to about 100,000 cP at a temperature of about 25° C., such as from about 200 cP to about 1,000 cP at about 25° C., from about 200 cP to about 5,000 cP at about 25° C., from about 200 cP to about 10,000 cP at about 25° C., from about 1,000 cP to about 10,000 cP at about 25° C., from about 1,000 cP to about 100,000 cP at about 25° C., from about 3,000 cP to about 100,000 cP at about 25° C., from about 4,000 cP to about 100,000 cP at about 25° C., from about 5,000 cP to about 100,000 cP at about 25° C., from about 6,000 cP to about 100,000 cP at about 25° C., from about 4,500 cP to about 7,000 cP at about 25° C., from about 40,000 cP to about 80,000 cP at about 25° C., from about 45,000 cP to about 75,000 cP at about 25° C., from about 50,000 cP to about 70,000 cP at about 25° C., from about 50,000 cP to about 60,000 cP at about 25° C., from about 50,000 cP to about 100,000 cP at about 25° C., or from about 70,000 cP to about 100,000 cP at about 25° C.

The resin formulation may also include a crosslinking agent, such as a radical initiator, a cationic initiator, or a catalyst, such as a hydrosilylation catalyst. The crosslinking agent initiates crosslinking of the polycarbosilane preceramic polymer and the organically modified silicon dioxide preceramic polymer by reacting the vinyl groups with silicon-hydrogen groups in the resin formulation. The radical initiator may be a peroxide compound or an azo compound used to cure (e.g., crosslink) the polycarbosilane preceramic polymer and the organically modified silicon dioxide preceramic polymer. The peroxide compound may include, but is not limited to, benzoyl peroxide, dicumyl peroxide, bis-(2,4-dichlorobenzoyl)-peroxide, or combinations thereof. The azo compound may include, but is not limited to, azobisisobutyronitrile. The cationic initiator may include a protonic acid, a Lewis acid/Friedel-Crafts catalyst (e.g., SnCl₄, AlCl₃, BF₃, and TiCl₄), carbenium ion salts (e.g., with trityl or tropylium cations), or through ionizing radiation. The hydrosilylation catalyst may be a transition metal catalyst, such as platinum, rhodium, ruthenium iridium, palladium, nickel, cobalt, iron, manganese, or combinations thereof. In some embodiments, the crosslinking agent is a platinum catalyst. The crosslinking agent may be present at an amount sufficient to react (e.g., crosslink) the polycarbosilane preceramic polymer and organically modified silicon dioxide preceramic polymer and selection of the crosslinking agent at least partially depends on the polycarbosilane preceramic polymer and organically modified silicon dioxide preceramic polymer used, as well as on the desired cure time of the resin formulation. The resin formulation may include the crosslinking agent at from about 0.1 wt % to about 2.5 wt %, such as from about 0.1 wt % to about 0.5 wt %, from about 0.5 wt % to about 1.0 wt %, from about 0.5 wt % to about 2.5 wt %, from about 0.8 wt % to about 1.2 wt %, from about 1.0 wt % to about 1.5 wt %, from about 1.0 wt % to about 2.0 wt %, from about 1.2 wt % to about 1.8 wt %, from about 1.5 wt % to about 2.0 wt %, from about 1.5 wt % to about 2.5 wt %, from about 1.8 wt % to about 2.2 wt %, or from about 2.0 wt % to about 2.5 wt %.

The resin formulation may include optional components (e.g., additives) to provide desirable properties to the article formed with the resin formulation. If present, the additive may be at least one compound that enhances at least one material property (e.g., ceramic yield, extent of cracking) of the article to be formed from the resin formulation. By way of example only, the additive may be a cure accelerator, an adhesion promoter, a lubricant, a filler, a pigment, or combinations thereof. Such additives are known in the art and are not described in detail herein. In some embodiments, the additive may include a ceramic powder including one or more of silicon carbide, silica, zirconia, and alumina. In some embodiments, the resin formulation is at least substantially free of additives other than the crosslinking agent (e.g., catalyst). Thus, in some embodiments, the resin formulation consists essentially of or consists of the polycarbosilane preceramic polymer, the organically modified silicon dioxide preceramic polymer, the crosslinking agent, and the carbon fibers, the carbon fibers optionally including the one or more metals. In some embodiments, the resin formulation comprises the polycarbosilane preceramic polymer at about 78.28 wt %, the organically modified silicon dioxide preceramic polymer at about 19.57 wt %, a platinum catalyst at about 0.98 wt %, and metallized carbon fibers exhibiting a length of about 1,000 um at about 1.17 wt %.

The resin formulation may be formed by combining (e.g., mixing) the polycarbosilane preceramic polymer, the organically modified silicon dioxide preceramic polymer, the carbon fibers, and any optional additives, then adding the crosslinking agent, if present. The polycarbosilane preceramic polymer, the organically modified silicon dioxide preceramic polymer, the carbon fibers including one or more metals, the crosslinking agent, if present, and any optional additives may be mixed by conventional techniques, such as by hand, using a high shear mixer, or using a planetary mixer. The components (e.g., the polycarbosilane preceramic polymer, the organically modified silicon dioxide preceramic polymer, the carbon fibers, the crosslinking agent, if present, and any optional additives) of the resin formulation may be mixed under vacuum to remove gases from the resin formulation and inhibit formation of voids or pores during curing and during conversion of the resin formulation to a ceramic material. The components may be mixed under inert conditions, such as under an argon atmosphere. The components of the resin formulation may be mixed for an amount of time sufficient to form an at least substantially homogeneous resin formulation (e.g., the polycarbosilane preceramic polymer, the organically modified silicon dioxide preceramic polymer, the carbon fibers, the crosslinking agent, if present, and any optional additives may be uniformly dispersed throughout the resin formulation) or a heterogeneous resin formulation (e.g., the polycarbosilane preceramic polymer, the organically modified silicon dioxide preceramic polymer, the carbon fibers, the crosslinking agent, if present, and any optional additives may be non-uniformly dispersed throughout the resin formulation). In some embodiments, the resin formulation is at least substantially homogeneous as formed. During mixing, the resin formulation may be maintained at a temperature below the lowest cure temperature of each of the components of the resin formulation. In one embodiments, the polycarbosilane preceramic polymer, the organically modified silicon dioxide preceramic polymer, the carbon fibers, the crosslinking agent, if present, and any optional additives are maintained at room temperature (e.g., from about 20° C. to about 25° C.) during mixing. A water-cooled jacket may be used, as needed, to maintain the resin formulation at or near room temperature to inhibit potential reactions from occurring during the mixing. The resin formulation may be a liquid at room temperature (e.g., from about 20° C. to about 25° C.).

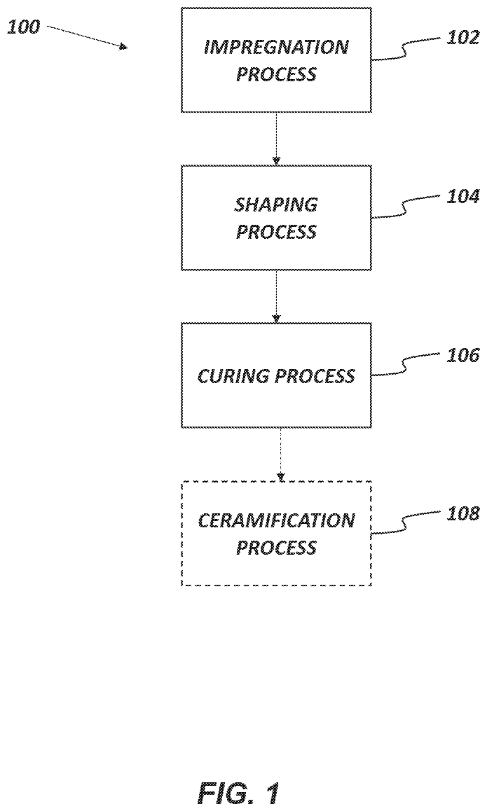

FIG. 1 illustrates a simplified flow diagram depicting a method 100 of forming a fiber reinforced article, according to embodiments of this disclosure. The method may include impregnating a fibrous reinforcement material with the resin formulation (e.g., an impregnation process) at act 102, forming the impregnated fibrous reinforcement material into a desired shape (e.g., a shaping process) at act 104, curing the resin formulation (e.g., a curing process) at act 106 to form the fiber reinforced article including a composite material, and, optionally, ceramifying the composite material (e.g., a ceramification process) at act 108 to form the fiber reinforced article including a ceramic material (e.g., CMC).

The fibrous reinforcement material may be a continuous fiber material or a fabric material. The fibrous reinforcement material may include one or more of carbon fibers, ceramic fibers, (e.g., oxide-based ceramic fibers, such as one or more of alumina fibers, alumina-silica fibers, and alumina-boria-silica fibers; non-oxide-based ceramic fibers, such as one or more of silicon carbide (SiC) fibers, silicon nitride (SiN) fibers, fibers including SiC on a carbon core, SiC fibers containing titanium, silicon oxycarbide fibers, silicon oxycarbonitride fibers; etc.), polymeric fibers (e.g., thermoplastic fibers, such as one or more of polyethylene (PE) fibers, polypropylene (PP) fibers, polystyrene (PS) fibers, polyvinyl chloride (PVC) fibers, poly (methyl methacrylate) (PMMA) fibers, polycarbonate (PC) fibers, polyphenylene oxide (PPO) fibers, polyetherketone (PEK) fibers, polyetheretherketone (PEEK) fibers, polyaryletherketone (PAEK) fibers, polyetherketoneketone (PEKK) fibers, polyetherketoneetherketoneketone (PEKEKK) fibers, polyether sulfone (PES) fibers, polyphenylene sulfide (PPS) fibers, polyphenylsulfone (PPSU) fibers, self-reinforced polyphenylene (SRP) fibers, aromatic polyamide (PA) fibers, and polyamideimide (PAI) fibers; thermoset plastic fibers, such as one or more of polyimide (PI) fibers, polyurethane (PU) fibers, phenol-formaldehyde fibers, urea-formaldehyde fibers, polyester fibers; etc.), glass fibers, boron fibers, and other fibers.

In some embodiments, the fibrous reinforcement material is electrically conductive. In some embodiments, the fibrous reinforcement material includes one or more metals. The one or more metals may be incorporated into the fibrous reinforcement material. The one or more metals may be incorporated into the fibrous reinforcement material in any suitable manner, such as, for example, as a coating on the fibrous reinforcement material, as a powder distributed within the fibrous reinforcement material, or as an additional fiber material within the fibrous reinforcement material. The one or more metals may exhibit a melting temperature greater than about 900° F. (greater than about 482° C.), such as, for example, greater than about 1,000° F. (greater than about 538° C.), greater than about 1,500° F. (greater than about 816° C.), greater than about 1,900° F. (greater than about 1,038° C.), greater than about 2,000° F. (greater than about 1,093° C.), or greater than about 3,000° F. (greater than about 1,649° C.). The metal may include one or more of copper, nickel, gold, silver, palladium, platinum, molybdenum, rhenium, and niobium.

In some embodiments, the fibrous reinforcement material is coated (e.g., metallized) with the one or more metals. In some embodiments, the fibrous reinforcement material is a metallized carbon fiber material. The fibrous reinforcement material may be coated with a concentration graded coating of the one or more metals. The fibrous reinforcement material may be coated with one coating or multiple coatings of one or more combinations (e.g., alloys) of the one or more metals, one coating or multiple coatings of a single metal material, or a combination thereof. The fibrous reinforcement material may be coated with a concentration graded coating of the one or more metals. The fibrous reinforcement material may be coated with a bilayer coating including two metals. In some embodiments, the fibrous reinforcement material is coated with a copper/nickel bilayer. A copper coating may be formed over (e.g., directly adjacent to) the fibrous reinforcement material and a nickel coating may be formed over (e.g., directly adjacent to) the copper coating. In some embodiments, the copper/nickel bilayer includes a concentration gradient of copper and nickel. As a non-limiting example, a concentration of copper may be highest adjacent to the fibrous reinforcement material and lowest adjacent an exterior surface of the bilayer coating and a concentration of nickel may be highest adjacent an exterior surface of the bilayer coating and lowest adjacent to the fibrous reinforcement material. In other embodiments, the copper/nickel bilayer includes a homogeneous copper coating over the fibrous reinforcement material and a homogeneous nickel coating over the homogeneous copper coating.

As shown at act 102, the fibrous reinforcement material is impregnated with the resin formulation in an impregnation process. The fibrous reinforcement material may be passed through (e.g., dipped or otherwise immersed) in a bath containing the resin formulation. Since the resin formulation is viscous, the resin formulation may impregnate into the fibrous reinforcement material, wetting the fibrous reinforcement material. The fibrous reinforcement material may, alternatively, be coated with the resin formulation, such as by brushing or otherwise applying the preceramic resin formulation to the fibrous reinforcement material.

As shown at act 104, the impregnated fibrous reinforcement material is formed (e.g., fabricated) into a desired configuration or shape of the fiber reinforced article, depending on an intended use of the fiber reinforced article, in a shaping process. By way of non-limiting example, the impregnated fibrous reinforcement material may be directly formed into a desired shape by coating, casting into a mold, dispensing from a container onto a surface as an adhesive or a sealant, hand placement (e.g., lay up), molding, such as vacuum bag molding or resin transfer molding, a composite lay-up process, such as wet filament winding, automated fiber placement, or a tape-laying process, another suitable process, or combinations thereof. The impregnated fibrous reinforcement material may be formed over a tool (e.g., a mandrel or a buck) configured to provide an internal shape of the fiber reinforced article. The internal shape of the fiber reinforced article may be any suitable shape, including, but not limited to, geometric shapes, asymmetric shapes, and an at least substantially cylindrical shape.

In some embodiments, the impregnated fibrous reinforcement material is formed into the desired configuration or shape by filament winding (e.g., wet filament winding). For example, the tool may rotate while the impregnated fibrous reinforcement material is wound under tension onto the tool. In another example, the tool may remain stationary and the impregnated fiber reinforcement material may be applied to the tool by rotating a distribution system around the tool. The distribution system may travel longitudinally along the tool applying the impregnated fiber reinforcement material in an at least substantially helical pattern (e.g., a diagonal pattern or a spiral pattern). In some embodiments, the impregnated fibrous reinforcement material is formed into the desired configuration or shape by a lay-up process. Sheets or plies (e.g., layers) of the impregnated fibrous reinforcement material may be wrapped around the tool to form the desired shape of the fiber reinforce article. In some embodiments, the impregnated fibrous reinforcement material is formed into the desired configuration or shape by a combination of two or more suitable processes.

Once formed into the desired shape (e.g., shaped article), the resin formulation in the shaped impregnated fibrous reinforcement material is cured (e.g., crosslinked, reacted) to form the fiber reinforced article in a curing process, as shown at act 106. The conditions used to cure the resin formulation may depend on the polycarbosilane preceramic polymer, the organically modified silicon dioxide preceramic polymer, and crosslinking agent (if present) included in the resin formulation. The resin formulation may be cured by exposure to a temperature within a range of from about 0° C. (about 32° F.) to about 400° C. (about 752° F.), such as from about 20° C. (about 68° F.) to about 371° C. (700° F.), from about 100° C. (about 212° F.) to about 400° C. (about 752° F.), from about 121° C. (about 250° F.) to about 371° C. (700° F.), or from about 20° C. (about 68° F.) to about 121° C. (about 250° F.). In some embodiments, the resin formulation is cured at a temperature of about 121° C. (about 250° F.). Depending on the cure temperature used, the resin formulation may be cured in an amount of time ranging from a few seconds (e.g., photoinitiated cure) to a few days. The resin formulation may be cured in hours, such as from about 1 hour to about 30 hours, from about 4 hours to about 20 hours, or from about 6 hours to about 10 hours. A shorter amount of time may be needed to cure the resin formulation at an increased (e.g., higher) cure temperature, while a longer amount of time may be needed to cure the resin formulation at a decreased (e.g., lower) cure temperature. The curing may be conducted using conventional processing equipment, which is not described in detail herein.

During curing, the polycarbosilane preceramic polymer and the organically modified silicon dioxide preceramic polymer react (e.g., crosslink), forming a composite material (e.g., cured resin formulation) as a rigid solid. Without being bound by any theory, it is believed that during the curing, the resin formulation is converted into an amorphous silicon-oxy-carbide material having the carbon fibers dispersed therein. The composite material, therefore, includes a reaction product of the polycarbosilane preceramic polymer and the organically modified silicon dioxide preceramic polymer, with the carbon fibers dispersed throughout. By way of non-limiting example, the vinyl groups of the resin formulation react with silicon-hydrogen bonds during the curing act. The curing may be conducted in a low oxygen environment (e.g., in an inert atmosphere environment), such as below 100 ppm of oxygen, to reduce oxidation of the polycarbosilane preceramic polymer and the organically modified silicon dioxide preceramic polymer.

The composite material may exhibit an electrical conductivity of within a range of from about 1×10⁴ S/m to about 1×10⁷ S/m at temperatures of up to about 5,000° F. (about 2,760° C.), such as within a range of from about 1×10⁴ S/m to about 1×10⁵ S/m, from about 1×10⁴ S/m to about 1×10⁶ S/m, from about 1×10⁵ S/m to about 1×10⁶ S/m, from about 1×10⁵ S/m to about 1×10⁷ S/m, or from about 1×10⁶ S/m to about 1×10⁷ S/m.

The composite material may exhibit sufficient material properties (e.g., rheological properties, mechanical properties, physical properties, chemical properties, thermal properties) after curing to provide the desired electrical conductivity and resistance to one or more of heat, moisture, and oxidation. The composite material may be stable to temperatures of up to about 5,000° F. (about 2,760° C.). The composite material may provide the fiber reinforced article with resistance to a temperature of up to about 5,000° F. (about 2,760° C.), such as from about 2,000° F. (about 1,093° C.) to about 5,000° F. (about 2,760° C.), from about 2,000° F. (about 1,093° C.) to about 3,000° F. (about 1,649° C.), from about 3,000° F. (about 1,649° C.) to about 4,000° F. (about 2,204° C.), from about 4,000° F. (about 2,204° C.) to about 5,000° F. (about 2,760° C.), from about 2,000° F. (about 1,093° C.) to about 4,000° F. (about 2,204° C.), or from about 3,000° F. (about 1,649° C.) to about 5,000° F. (about 2,760° C.). The fiber reinforced article formed of the composite material may also exhibit reduced mass loss and reduced corrosion.

As shown at act 108, the composite material may be ceramified to further harden the composite material and to convert the composite material into a ceramic material (e.g., ceramified resin formulation) in a ceramification process. Without being bound by any theory, it is believed that during curing and ceramification, the resin formulation is converted into an amorphous silicon-oxy-carbide material with the filler dispersed therein. The ceramic material, therefore, includes a reaction product of the polycarbosilane preceramic polymer and the organically modified silicon dioxide preceramic polymer with the carbon fibers dispersed throughout. The composite material may be exposed to a temperature of greater than about 650° C. (greater than about 1,200° F.), such as a temperature of greater than about 816° C. (greater than about 1,500° F.) or greater than about 1,093° C. (greater than about 2,000° F.) to ceramify the composite material. By way of non-limiting example, the ceramification temperature may range from about 650° C. (about 1,200° F.) to about 1,093° C. (about 2,000° F.), from about 816° C. (about 1,500° F.) to about 1,093° C. (about 2,000° F.), from about 816° C. to about 1,200° C. (about 2,192° F.), or greater. In some embodiments, the composite material is ceramified at a temperature of about 1,093° C. (about 2,000° F.). In some embodiments, the impregnated fibrous reinforcement material is cured and ceramified by a single heat treatment, such as at a temperature of about 1,200° C. (about 2,192° F.). The ceramic yield of the ceramic material may be greater than about 50%, such as greater than about 70%, greater than about 75%, greater than about 80%, greater than about 90%, or greater than about 95% when ceramified at these temperatures. Without being bound by any theory, it is believed that the high degree of quaternary coordinate oxygen in the organically modified silicon dioxide preceramic polymer results in the high ceramic yield. When silicon atoms are fully coordinated with oxygen atoms, SiO₂ is maintained during the cure and ceramification. The organically modified silicon dioxide preceramic polymer has sufficient organic groups bonded to the silicon atoms to keep the resin formulation in a polymeric state, which enables case of blending with other materials. It is also believed that at a temperature of about 1,093° C. (about 2,000° F.), the resin formulation may be characterized as a semi-amorphous silicon-oxy-carbide material.

The ceramification may be conducted during use and operation (e.g., in situ) of the fiber reinforced article. By way of example only, if the fiber reinforced article formed of the composite material (e.g., cured resin formulation) is configured as a rocket motor nozzle, the composite material may be converted to the ceramic material (e.g., ceramified resin formulation) during use and operation of the rocket motor nozzle. By ceramifying the composite material in situ, fewer process acts are conducted to produce the fiber reinforced article. Therefore, the overall cost of fiber reinforced articles formed according to embodiments of the disclosure may be lower than the cost of conventional articles formed by conventional processes. By conducting the ceramification in situ, the risk of damage to the fiber reinforced article is also reduced because the high temperature ceramification is conducted just before use and operation of the fiber reinforced article. Forming the fiber reinforced article according to embodiments of the disclosure may also be more efficient because less damage occurs to the article.

Alternatively, the ceramification may be conducted before use and operation of the fiber reinforced article. The composite material may be exposed to a temperature sufficient to ceramify the composite, and form the desired fiber reinforced article including the ceramic material.

The composite material may exhibit an electrical conductivity of within a range of from about 1×10⁴ S/m to about 1×10⁷ S/m at temperatures of up to about 5,000° F. (about 2,760° C.), such as within a range of from about 1×10⁴ S/m to about 1×10⁵ S/m, from about 1×10⁴ S/m to about 1×10⁶ S/m, from about 1×10⁵ S/m to about 1×10⁶ S/m, from about 1×10⁵ S/m to about 1×10⁷ S/m, or from about 1×10⁶ S/m to about 1×10⁷ S/m.

The ceramic material may exhibit sufficient material properties (e.g., rheological properties, mechanical properties, physical properties, chemical properties, thermal properties) after ceramification to provide the desired electrical conductivity and resistance to one or more of heat, moisture, and oxidation. The ceramic material may be stable to temperatures of up to about 5,000° F. (about 2,760° C.). The ceramic material may provide the fiber reinforced article with resistance to a temperature of up to about 5,000° F. (about 2,760° C.), such as from about 2,000° F. (about 1,093° C.) to about 5,000° F. (about 2,760° C.), from about 2,000° F. (about 1,093° C.) to about 3,000° F. (about 1,649° C.), from about 3,000° F. (about 1,649° C.) to about 4,000° F. (about 2,204° C.), from about 4,000° F. (about 2,204° C.) to about 5,000° F. (about 2,760° C.), from about 2,000° F. (about 1,093° C.) to about 4,000° F. (about 2,204° C.), or from about 3,000° F. (about 1,649° C.) to about 5,000° F. (about 2,760° C.). The fiber reinforced article formed of the ceramic material may also exhibit reduced mass loss and reduced corrosion.

By forming the composite material or the ceramic material by the filament winding process, the composite material or the ceramic material may be formed into a net-shape or near-net shape. The impregnated fibrous reinforcement material, therefore, does not need to be formed into a tape or other form, which is then formed into the desired shape. Rather, the composite material or the ceramic material is directly formed from the impregnated fibrous reinforcement material. The composite material may also be machined (e.g., machincable) during at least a portion of its fabrication. By way of non-limiting example, an outer diameter of the composite material may be machined after curing to form the desired shape.

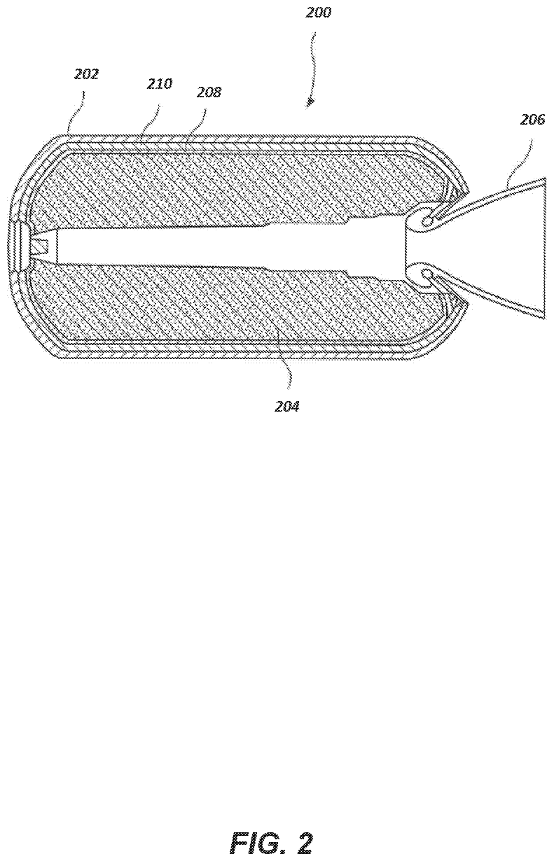

The composite material or the ceramic material formed from the impregnated fibrous reinforcement material may be used in a variety of articles, such as in aerospace articles or other industrial articles that are desirably electrically conductive and resistant to one or more of heat, moisture, and oxidation. FIG. 2 is a simplified-cross sectional view of a rocket motor 200 (e.g., a solid rocket motor, a liquid rocket motor), in accordance with embodiments of the disclosure. The rocket motor 200 may, for example, be configured to be a component (e.g., stage) of a larger assembly (e.g., a multi-stage rocket motor assembly). As shown in FIG. 2, the rocket motor 200 includes a casing 202, a propellant structure 204 disposed within the casing 202, and a nozzle assembly 206 connected to an aft end of the casing 202. The rocket motor 200 may also include one or more of a liner structure 208 and an insulation structure 210 between the propellant structure 204 and the casing 202. For example, the liner structure 208 may be located on or over the propellant structure 204, and the insulation structure 210 may be located on and between the liner structure 208 and an inner surface of the casing 202. The components of the rocket motor 200 may be formed using conventional processes and equipment, which are not described in detail herein. The composite material or the ceramic material according to embodiments of this disclosure may be used in one or more components of the rocket motor 200. By way of non-limiting example, at least a portion of the nozzle assembly 206 and/or the casing 202 may be formed of and include the composite material or the ceramic material according to embodiments of this disclosure.

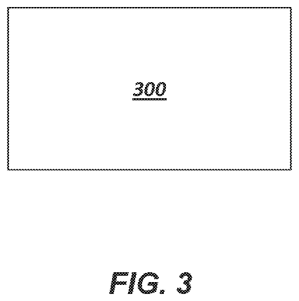

FIG. 3 is a block diagram of a fiber reinforced article 300, in accordance with embodiments of this disclosure. The fiber reinforced article 300 includes the composite or the ceramic material according to embodiments of this disclosure. The fiber reinforced article 300 may be used as a structural component of a rocket, a rocket motor (e.g., a solid rocket motor, a liquid rocket motor), a hypersonic vehicle, or other acrostructure. The acrostructure may include, but is not limited to, a turbine, a turbine blade, a turbine housing, a turbine engine vane, an insulating tile, a rotor blade, an insulation blanket, insulation, a compressor blade, a wing component, a fuselage skin, landing gear, a shroud, an exhaust nozzle, an engine exhaust duct, a nose cone, a guidance system, a control system, an electronic system, a re-entry shield, and/or a heat shield. In some embodiments, the fiber reinforced article 300 is a nose cone formed of and including the composite material or the ceramic material according to embodiments of this disclosure. In some embodiments, the fiber reinforced article 300 is configured to shield an electronic system (e.g., a guidance system, a control system) of the aerostructure from electromagnetic energy (e.g., laser energy, microwave energy, electromagnetic pulse energy), space environment conditions (e.g., particles, cosmic radiation), or natural threats (e.g., lightning).

The resin formulations and fiber reinforced articles (e.g., components of rocket motor 200, the article 300) of the disclosure advantageously facilitate one or more of improved durability and reliability, improved stability at increased temperatures, improved electrical conductivity at high temperatures, and decreased manufacturing cost, as compared to conventional resin formulations and conventional articles. By including one or more metals in the carbon fibers and/or the fibrous reinforcement material, the resin formulations and articles may be electrically conductive at high temperatures. The electrically conductive resin formulations and articles may facilitate improved protection and reliability of electronic devices, equipment, and systems in aerospace and other industries by providing adequate shielding from electromagnetic energy (e.g., electromagnetic interference), such as, for example, laser energy, microwave energy, and electromagnetic pulse energy, at higher temperatures as compared to conventional resin formulations and conventional articles. By modifying the individual length of the carbon fibers, the viscosity of the resin formulation may be tailored for specific article manufacturing processes, such as wet filament winding. Furthermore, in embodiments where the resin formulations are at least substantially free of a solvent and a volatile, articles produced with the resin formulations have decreased porosity and exhibit improved durability. The methods of the disclosure facilitate the formation of resin formulations and articles having one or more of improved durability and reliability, improved stability at increased temperatures, improved electrical conductivity, and decreased manufacturing cost as compared to conventional resin formulations and conventional articles.

The following example serves to explain embodiments of the disclosure in more detail. This example is not to be construed as being exhaustive or exclusive as to the scope of this disclosure.

### EXAMPLE 1

Various embodiments according to the present disclosure including the ingredients in Table 1 were prepared by combining the ingredients in the amounts listed to form Compositions 1A and 1B. Each of the ingredients is commercially available and may be purchased from commercial sources including, but not limited to, EEMS, LLC, Starfire Systems, Inc., Matech, Grafil, Inc., Toho Tenax Co., Ltd., Toray Industries, Inc., SGL Carbon SE, Hexcel Co., etc.

TABLE 1
Resin Compositions of Compositions 1A and 1B

| | Composition 1A | Composition 1B |
|---|---|---|
| Ingredient | (wt %) | (wt %) |
| Polycarbosilane | 35 | 65 |
| preceramic polymer | | |
| Platinum- | 0.5 | 0.5 |
| octanaldehyde/octanol | | |
| complex | | |
| Silicon carbide | 62.5 | 33.5 |
| powder | | |
| Copper metallized | 2 | 1 |
| IM7 carbon fiber¹ | | |

¹IM7 carbon fiber is commercially available from Hexcel Co. as HexTow ® IM7 carbon fiber tradename

After curing and/or ceramificiation, Compositions 1A and 1B each exhibited relatively high electrical conductivity at temperatures of up to about 1,800° F. (about 982° C.). Composition 1A exhibited a surface resistance of less than or equal to about 100 Ω/sq. Composition 1B exhibited a surface resistance of greater than or equal to about 1000 Ω/sq.

While the disclosure is susceptible to various modifications and alternative forms, specific embodiments have been shown by way of example in the drawings and have been described in detail herein. However, the disclosure is not intended to be limited to the particular forms disclosed. Rather, the disclosure encompasses all modifications, equivalents, and alternatives falling within the scope of the disclosure as defined by the following appended claims and their legal equivalents.

What is claimed is:

1. A resin formulation, comprising, before cure:
at least one polymer derived ceramic (PDC) resin; and
carbon fibers comprising one or more metals,
wherein the resin formulation is at least substantially free of a solvent.

2. The resin formulation of claim 1, wherein the at least one PDC resin comprises one or more of at least one polycarbosilane preceramic polymer and at least one organically modified silicon dioxide preceramic polymer.

3. The resin formulation of claim 1, wherein the carbon fibers comprise one or more of copper, nickel, silver, gold, palladium, platinum, molybdenum, rhenium, and niobium.

4. The resin formulation of claim 1, wherein the carbon fibers have a length of from about 100 microns (μm) to about 3,000 μm.

5. The resin formulation of claim 1, wherein the resin formulation comprises the carbon fibers at from about 0.2% by volume (vol %) to about 1.5 vol %.

6. The resin formulation of claim 1, further comprising a catalyst at from about 0.1% by weight (wt %) to about 2.5 wt %.

7. The resin formulation of claim 1, wherein the resin formulation exhibits a viscosity within a range of from about 200 cP to about 10,000 cP at about 25° C.

8. The resin formulation of claim 1, wherein the carbon fibers have a length of about 1,000 μm and the resin formulation exhibits a viscosity of about 1,000 cP at about 25° C.

9. The resin formulation of claim 1, wherein the carbon fibers are coated with nickel.

10. An article comprising:
a fibrous reinforcement material;
a reaction product of at least one polymer derived ceramic (PDC) resin; and
carbon fibers,
wherein at least one of the fibrous reinforcement material and the carbon fibers comprises one or more metals.

11. The article of claim 10, wherein the at least one PDC resin comprises one or more of at least one polycarbosilane preceramic polymer and at least one organically modified silicon dioxide preceramic polymer.

12. The article of claim 10, wherein the one or more metals comprises one or more of copper, nickel, silver, gold, palladium, platinum, molybdenum, rhenium, and niobium.

13. The article of claim 10, wherein the article is configured as at least a portion of a rocket motor nozzle or a rocket motor casing.

14. The article of claim 10, wherein the article is configured to be electrically conductive at a temperature of up to about 2,760° C.

15. A method of forming an article, comprising:
impregnating a fibrous reinforcement material with a resin formulation, the resin formulation comprising, before cure:
at least one polymer derived ceramic (PDC) resin; and
fibers comprising carbon and at least one metal,
wherein the resin formulation is at least substantially free of a solvent;
forming the impregnated fibrous reinforcement material into a desired shape; and
curing the impregnated fibrous reinforcement material to form the article.

16. The method of claim 15, wherein forming the impregnated fibrous reinforcement material into a desired shape comprises winding the impregnated fibrous reinforcement material on a mandrel to form the desired shape comprising multiple layers of the impregnated fibrous material.

17. The method of claim 15, wherein impregnating a fibrous reinforcement material with a resin formulation comprises passing the fibrous reinforcement material through the resin formulation or coating the fibrous reinforcement material with the resin formulation, the resin formulation exhibiting a viscosity of from about 200 cP to about 5,000 cP at about 25° C.

18. The method of claim 15, wherein impregnating a fibrous reinforcement material with a resin formulation comprises impregnating the fibrous reinforcement material with the resin formulation, wherein at least one of the fibers and the fibrous reinforcement material comprises one or more of copper, nickel, silver, gold, palladium, platinum, molybdenum, rhenium, and niobium.

19. The method of forming an article of claim 15, wherein curing the impregnated fibrous reinforcement material comprises curing the resin formulation at a temperature within a range of from about 100° C. to about 400° C.

20. The method of forming a composite article of claim 15, further comprising, after or substantially simultaneously with curing the impregnated fibrous reinforcement material, ceramifying the article at a temperature of about 1,200° C.
